(19) United States
(12) Patent Application Publication
(10) Pub. No.: US 2011/0102269 A1
(43) Pub. Date: May 5, 2011

(54) PATCH ANTENNA

(76) Inventors: Masato Sato, Tokyo (JP); Hiroyuki Iwasaki, Tokyo (JP); Shinji Iino, Tokyo (JP)

(21) Appl. No.: 12/898,022

(22) Filed: Oct. 5, 2010

(30) Foreign Application Priority Data
Nov. 2, 2009 (JP) 2009-252295

(51) Int. Cl. H01Q 9/14; H01Q 1/38

(52) U.S. Cl. 343/700 MS

(57) ABSTRACT

The patch antenna disclosed is easily adjusting the resonant frequency even by manual operation and without requiring a grinding process. A patch antenna includes a radiating element 12 and an adjustment land section 20. A power supply section 11 is disposed in the radiating element 12. The adjustment land section 20 adjusts the resonant frequency of the radiating element 12. When the resonant frequency needs to be adjusted, the adjustment land section 20 and the radiating element 12 are short-circuited to change the element length as viewed from the power supply section 11. As a result, the resonant frequency of the radiating element 12 can be adjusted.

### BACKGROUND OF THE INVENTION

1. Technical Field

The present invention relates to a patch antenna, and more particularly to a patch antenna capable of adjusting resonant frequency.

2. Background Art

A patch antenna has been used in a wireless LAN, a GPS, a mobile phone, and the like. The patch antenna typically has a ground plate as one surface of a double-side substrate and a radiating element patterned on the other surface thereof.

The resonant frequency of such a patch antenna varies with an error in the dimension, etc. of the radiating element. Thus, there may be a case where an irregular patch antenna in which the resonant frequency thereof deviates from a desired value is manufactured due to a dimensional error caused in the manufacturing process of the patch antenna. In the technique disclosed in. e.g., Patent Document 1 (Japanese Patent Application Kokai Publication No. Hei 06-276013) and Patent Document 2 (Japanese Patent Application Kokai Publication No. 2008-236362), a cut section is formed in such an irregular patch antenna so as to allow adjustment of the resonant frequency thereof during the manufacturing process. That is, in Patent Documents 1 and 2, a patch antenna having no cut section formed in the radiating element is manufactured and then the resonant frequency of the patch antenna is measured. If the patch antenna is determined to be an irregular, the cut portion is formed in a grinding process so as to increase (Patent Document 1) or decrease (Patent Document 2) the resonant frequency.

The resonant frequency of such a patch antenna may deviate from a desired value not only due to a patterning error of the radiating element but also due to an error in the dielectric constant of a dielectric substrate even if the radiating element is formed properly. Thus, how much the resonant frequency deviates from a desired value can be determined only after the patch antenna has been manufactured. However, in the technique disclosed in Patent Documents 1 and 2, the cut section is formed in the radiating element through a grinding process, so that manual adjustment of the resonant frequency is difficult. Further, in the technique of Patent Documents 1 and 2, the resonant frequency can be adjusted in only one direction (i.e., increasing direction or decreasing direction), which may not be satisfactory as an adjusting means.

### SUMMARY OF THE INVENTION

The present invention has been made in view of the above situation, and an object thereof is to provide a patch antenna capable of easily adjusting the resonant frequency even by manual operation and without requiring a grinding process.

To attain the above object of the present invention, a patch antenna according to the present invention may include: a radiating element having a power supply section; and an adjustment land section for adjusting a resonant frequency of the radiating element, the adjustment land section being short-circuited to the radiating element so as to change an element length of the radiating element as viewed from the power supply section to thereby adjust the resonant frequency of the radiating element.

The radiating element may have an opening section in a center thereof, and the adjustment land section may include an inner land section disposed within the opening section at a section adjacent to the radiating element.

A plurality of inner land sections may be disposed symmetrically with respect to a line connecting the power supply section and a side of the opening section remote from the power supply section or disposed symmetrically with respect to a center point of the opening section.

The opening section may have a substantially square shape, the inner land section may have a substantially triangular shape and is disposed in such a manner that a first apex of the triangular shape is connected near a corner of the opening section and a second apex thereof is away from the corner of the opening section, and when the resonant frequency needs to be adjusted, a third apex of the triangular shape may be short-circuited to the radiating element.

The adjustment land section may include an exterior land section disposed around the radiating element at the section adjacent to a side of the radiating element remote from the power supply section.

The exterior land section may have a convex shape, and a projection of the convex shape may be disposed facing to the radiating element side.

The radiating element may have a plurality of power supply sections, and a plurality of adjustment land sections may be provided so as to change the element length as viewed from the power supply sections.

The radiating element may have a recess section at a periphery of the radiating element, and the adjustment land section may have an internal land section disposed within the recess section.

The adjustment land section may further include an exterior land section having a convex shape and disposed adjacent to a periphery of the radiating element, and a projection of the convex shape may be disposed facing to the radiating element side.

The adjustment land section and the radiating element are short-circuited by soldering or by a 0Ω resistor.

The patch antenna may further comprise an adjustment projection extending from the radiating element, the adjustment projection is cut so as to change the element length as viewed from the power supply section.

The patch antenna of the present invention has an advantage of being able to easily adjust the resonant frequency even by manual operation and without requiring a grinding process.

### BRIEF DESCRIPTION OF DRAWINGS

FIG. 1 is a schematic top view for explaining a patch antenna according to the present invention.

FIG. 2 is a schematic top view for explaining another example of the patch antenna according to the present invention.

FIG. 3 is a schematic top view for explaining another example of the shape of inner land sections serving as an adjustment land section of the patch antenna according to the present invention.

FIG. 4 is a schematic top view for explaining still another example of the patch antenna according to the present invention.

FIG. 5 is a schematic top view for explaining a two-channel patch antenna according to the present invention.

FIG. 6 is a schematic top view for explaining an example in which the resonance frequency is shifted to a higher value in the patch antenna according to the present invention of FIG. 5.

FIG. 7 is a schematic top view for explaining an example in which a recess section and an internal land section within the recess section are disposed at a periphery of the radiating element of the patch antenna according to the present invention.

FIG. 8 is a schematic top view for explaining an example in which an adjustment projection is provided in the patch antenna of the present invention.

### PREFERRED EMBODIMENTS OF THE INVENTION

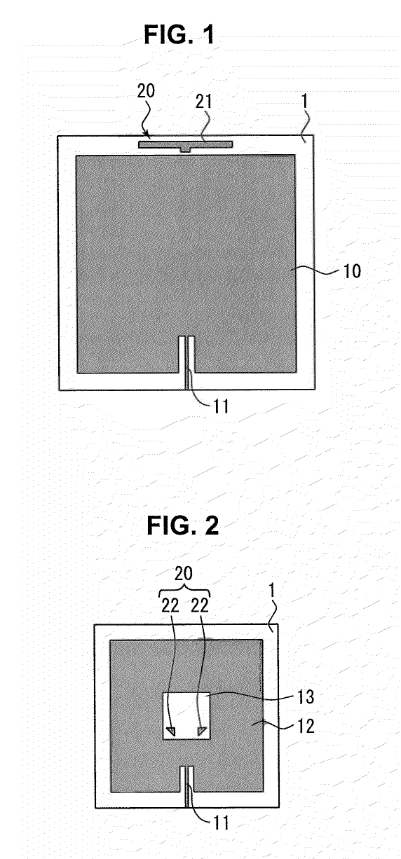

An embodiment for practicing the present invention will be described below with reference to the accompanying drawings. FIG. 1 is a schematic top view for explaining a patch antenna according to the present invention. As shown in FIG. 1, the patch antenna of the present invention mainly includes a radiating element 10 formed on a dielectric substrate 1 and an adjustment land section 20.

A power supply section 11 is connected to the radiating element 10. Although the radiating element 10 is for a linear-polarized patch antenna and the radiation element 10 shown in FIG. 1 has substantially a square shape, the present invention is not limited to this but the radiating element 10 may have, e.g., a circular shape. Further, although the power supply section 11 is provided in the form of a microstrip line in a cut section formed in the radiating element 10, the present invention is not limited to this but power supply may be achieved through a power supply pin, etc.

The adjustment land section 20 adjusts the resonant frequency of the radiating element 10. The adjustment land section 20 is configured to be short-circuited to the radiating element 10 to change the element length of the radiating element 10 as viewed from the power supply section 11, thereby adjusting the resonant frequency of the radiating element 10. The shape of the adjustment land section 20 is not limited to the shape shown in the drawing as long as the adjustment land section 20 can change the element length as viewed from the power supply section 11.

FIG. 1 shows an example in which the adjustment land section 20 is formed as an exterior land section 21 which is disposed around the radiating element 10 at the section adjacent to the side of the radiating element 10 remote from the power supply section 11. The exterior land section 21 has a convex shape, and the projection of the convex shape is disposed facing to the patch antenna element side. The configuration in which the projection of the convex shape is disposed facing to the patch antenna element side minimizes the influence on the radiating element 10 when the exterior land section 21 is not short-circuited to the radiating element 10. It is only necessary that the adjustment land section 20 be disposed away from the radiating element 10 to such a degree that it is not capacitive coupled to the radiating element 10. The exterior land section as the adjustment land section for the patch antenna of the present invention is preferably disposed symmetrically to the power supply section.

If the resonant frequency of the manufactured patch antenna having such an element pattern deviates from a desired value to be higher than the same, the exterior land section 21 and the radiating element 10 are short-circuited by soldering. As a result, the element length of the radiating element 10 as viewed from the power supply section 11 is increased by the length corresponding to the exterior land section 21, allowing the resonant frequency to be shifted to a lower value. The short-circuiting between the exterior land section 21 and the radiating element 10 may be achieved by a 0Ω resistor. When a greater number of adjustments are required in the manufacturing line, the short-circuiting is achieved by mounting the 0Ω resistor using a machine such as a chip mounter. It is preferable that a resist film, etc., be removed from the to-be-soldered sections of the radiating element 10 and the adjustment land section 20 so as to facilitate soldering thereto.

FIG. 2 is a schematic top view for explaining another example of the patch antenna according to the present invention. In FIG. 2, the parts having the same reference numerals as in FIG. 1 are substantially identical with those of the same reference numbers shown in FIG. 1. FIG. 2 shows an example in which a radiating element 12 has an opening section 13 in the center thereof. This configuration is adopted for the purpose of reducing the size of the patch antenna. That is, when the size of the radiating element 12 is reduced, the element length is correspondingly reduced and thereby the resonant frequency becomes higher; while by forming the opening section 13, adjustment to a desired resonant frequency can be achieved, whereby the size reduction can be realized.

In the present invention, the adjustment land section 20 of the patch antenna having such a configuration is formed as inner land sections 22, 22 which are arranged inside the opening section 13 at the sections adjacent to the radiating element 12. It is sufficient that at least one inner land section 22 is provided in the opening section 13. Preferably, as shown in FIG. 2, two inner land sections 22, 22 are provided symmetrically with respect to a line connecting the power supply section 11 and the side of the opening section 13 remote from the power supply section 11. It is only necessary that the adjustment land section 20 be disposed away from the radiating element 12 to such a degree that it is not capacitively-coupled to the radiating element 12.

The inner land sections 22, 22 as the adjustment land section 20 will be described more in detail. In the case where the opening section 13 is formed into a substantially square shape, the inner land sections 22, 22 are disposed adjacent to the corners of the opening section 13. For example, the inner land sections 22, 22 each have a substantially triangular shape. By forming each of the inner land sections 22, 22 into a triangular shape and disposing each of them in such a manner that one apex of the triangle is away from the corner of the opening section 13, the influence on the radiating element 12 when the inner land sections 22, 22 are not short-circuited to the radiating element 12 is minimized.

If the resonant frequency of the manufactured patch antenna having such an element pattern deviates from a desired value to be lower than the same, the inner land sections 22, 22 and the radiating element 12 are short-circuited by soldering. As a result, the element length of the radiating element 12 as viewed from the power supply section 11 is reduced by the short-circuiting to the inner land sections 22, 22, allowing the resonant frequency to be shifted to a higher value. The short-circuiting between the inner land sections 22, 22 and the radiating element 10 may be achieved by a 0Ω resistor, as described above.

Although two inner land sections are disposed line-symmetrically in the above example, the present invention is not limited to this. For example, four inner land sections may be provided at all the four corners of the opening section 13. In the case where a plurality of inner land sections are provided, by changing the number of the inner land sections to be short-circuited to the radiating element, it is possible to increase the resonant frequency in a stepwise manner. That is, the shift width of the resonant frequency can be adjusted finely.

Preferably, the inner land sections as the adjustment land section of the patch antenna according to the present invention are disposed in a symmetric relationship. For example, the inner land sections may be disposed symmetrically with respect to the center point of the opening section, or may be disposed symmetrically with respect to a line connecting the power supply section and the side of the opening section remote from the power supply section.

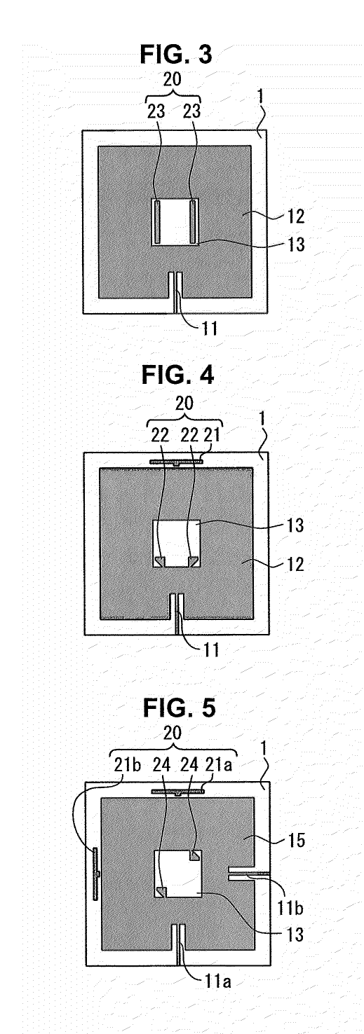

Further, the shape of the adjustment land section of the patch antenna according to the present invention is not limited to the triangular shape as shown in FIG. 2. FIG. 3 is a schematic top view for explaining another example of the shape of the inner land sections as the adjustment land section. In FIG. 3, the parts having the same reference numerals as in FIG. 2 are substantially identical with those of the same reference numbers shown in FIG. 2. In the example of FIG. 3, two strip-shaped inner land sections 23, 23 are disposed within the opening section 13 in a symmetric manner with respect to a line connecting the power supply section 11 and the side of the opening section 13 remote from the power supply section 11. Even in the case of the inner land sections 23, 23 having such a configuration, by short-circuiting both ends of each of the strip-shaped inner land sections 23, 23 to the radiating element 12, the resonant frequency can be adjusted. That is, the element length of the radiating element 12 as viewed from the power supply section 11 is reduced by the short-circuiting, allowing the resonant frequency to be shifted to a higher value.

FIG. 4 is a schematic top view for explaining still another example of the patch antenna according to the present invention. In FIG. 4, the parts having the same reference numerals as in FIGS. 1 and 2 are substantially identical with those of the same reference numbers shown in FIGS. 1 and 2. The patch antenna shown in FIG. 4 has a configuration obtained by combining the configurations shown in FIGS. 1 and 2. That is, the adjustment land section 20 includes the exterior land section 21 and the inner land sections 22, 22. The inner land sections 22, 22 each have a substantially triangular shape and each disposed in such a manner that one apex of the triangle is connected near the corner of the opening section 13 and one apex of the other two apexes thereof is away from the corner of the opening section 13. When the resonant frequency needs to be adjusted, the remaining one apex of the triangle is short-circuited to the radiating element 12 and thereby the resonant frequency can be shifted to a higher value. Two sections of each of the inner land sections are short-circuited to the radiating element in the example shown in FIG. 2; while in the example shown in FIG. 4, one apex of the triangle is previously connected near the corner of the opening section so as to allow achievement of the adjustment of the resonant frequency by one short-circuiting point. However, the present invention is not limited to this, but the adjustment land section 20 may have the same configuration as that shown in FIG. 2 or any other configuration as long as the element length can be reduced by the short-circuiting.

When the resonant frequency needs to be adjusted in the patch antenna of the present invention shown in FIG. 4 after the manufacturing of the patch antenna, the adjustment is carried out as follows. That is, when the resonant frequency deviates from a desired value to be higher than the same, the exterior land section 21 and the radiating element 12 are short-circuited by soldering, etc. As a result, it is possible to shift the resonant frequency to a lower value. On the other hand, when the resonant frequency deviates from a desired value to be lower than the same, the inner land sections 22, 22 and the radiating element 12 are short-circuited by soldering, etc. As a result, it is possible to shift the resonant frequency to a higher value.

As described above, according to the patch antenna of the present invention in which the exterior land section and the inner land sections are provided, it is possible to adjust (increase or decrease) the resonant frequency only by the short-circuiting by means of a soldering process, etc., without performing a pattern cutting process by means of grinding. In the case where the pattern cutting process is performed, there may be a possibility that the pattern may excessively is cut or a wrong part is erroneously cut; however, according to the present invention, it is sufficient to perform only soldering, so that the adjustment work can be conducted even by, e.g., an operator with little knowledge of electricity. Further, it is possible to prevent a wrong part from being soldered by removing a resist film only at a part to be soldered.

Although a one-channel patch antenna having one power supply section has been described in the above examples, the present invention may be applied to a two-channel patch antenna. FIG. 5 is a schematic top view for explaining a two-channel patch antenna according to the present invention. In FIG. 5, the parts having the same reference numerals as in FIGS. 1 and 2 are substantially identical with those of the same reference numbers shown in FIGS. 1 and 2. As shown in FIG. 5, the two-channel patch antenna of the present invention has a configuration obtained by providing another power supply section in a perpendicular manner with respect to the patch antenna shown in FIG. 4. That is, a radiating element 15 has a plurality of power supply sections 11a and 11b. Further, a plurality of adjustment land sections 20 are provided so as to change the element length as viewed from the power supply sections 11a and 11b, respectively. More in detail, exterior land sections 21a and 21b as the adjustment land section 20 are disposed corresponding to the power supply sections 11a and 11b around the radiating element 15 at the sections adjacent to the sides of the radiating element 15 remote from the power supply sections, respectively. Further, inner land sections 24, 24 are disposed at the lower left and upper right corners of the opening section 13 in FIG. 5. That is, the inner land sections 24, 24 are disposed symmetrically with respect to the center point of the opening section 13.

The patch antenna having such a configuration may be used as a MIMO (Multiple Input Multiple Output) antenna. Further, in the case where the patch antenna of FIG. 5 is configured such that different signals are input to the power supply sections, it can function as a multi-band patch antenna. Even in the case of such a two-channel patch antenna, when the resonant frequency deviates from a desired value, the exterior land sections are short-circuited to the radiating element to thereby allow the resonant frequency to be shifted to a lower value or the inner land sections are short-circuited to the radiation element to thereby allow the resonant frequency to be shifted to a higher value.

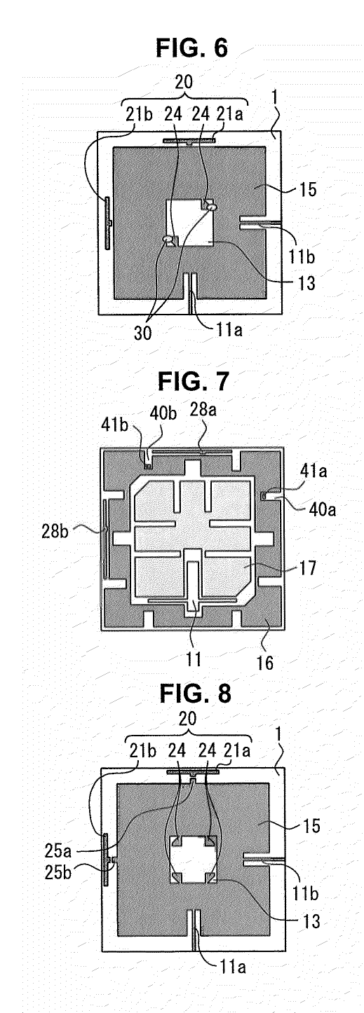

FIG. 6 is a schematic top view for explaining an example in which the resonance frequency is shifted to a higher value in the patch antenna according to the present invention. In FIG. 6, the parts having the same reference numerals as in FIG. 5 are substantially identical with those of the same reference numbers shown in FIG. 5. FIG. 6 shows a case where the resonant frequency is shifted to a higher value. As shown in FIG. 6, the inner land sections 24, 24 as the adjustment land section 20 are short-circuited to the radiating element 15 by a solder 30. As a result, the resonant frequency is shifted to a higher value. The inner land sections 24, 24 give influence on the radiation characteristics of the power supply sections 11a and 11b and, therefore, the resonant frequencies of both two channels can be shifted to a higher value.

The patch antenna according to the present invention illustrated in FIGS. 2 to 6 in which the opening section is provided within the radiating element and the inner land section is provided therein is explained above. However, the present invention is not limited to this, but a recess section and an internal land section within the recess section may be provided at a periphery of the radiating element. FIG. 7 is a schematic top view for explaining an example in which a recess section and an internal land section within the recess section are disposed at a periphery of the radiating element of the patch antenna to the present invention. In FIG. 7, the parts having the same reference numerals as in FIG. 1 or 2 are substantially identical with those of the same reference numbers shown in FIG. 1 or 2. In the illustrated example, a circular-polarized patch antenna is shown. Specifically, The outer radiating element 16 is for GPS, and the inner radiating element 17 is for SDARS. However, the present invention is not limited to the illustrated pattern of the radiating element. Additionally, there is no adjustment land section for the radiating element 17 shown in FIG. 7, but the present invention is not limited to this and an internal land section may be provided within a recess section of the radiating element 17 like the radiating element 16.

As shown in FIG. 7, the radiating element 16 has recess sections 40a, 40b at a periphery thereof. Internal land sections 41a, 41b are disposed as the adjustment land section within the recess sections 40a, 40b, respectively. The internal land sections 41a, 41b is for adjusting a resonant frequency of the radiating element 16. When the resonant frequency of the radiating element 16 deviates from a desired value to be lower than the same, the recess sections 40a, 40b and the internal land sections 41a, 41b are short-circuited by soldering, etc., respectively. As a result, the element length of the radiating element 16 as viewed from the power supply section 11 is reduced by the short-circuiting, allowing the resonant frequency to be shifted to a higher value.

Further, exterior land sections 28a, 28b having a convex shape may be provided as the adjustment land section around the radiating element 16. The projection of the convex shape of each of the exterior land sections 28a, 28b is disposed facing to the radiating element 16 side. When the resonant frequency of the radiating element 16 deviates from a desired value to be higher than the same, the exterior land sections 28a, 28b and the radiating element 16 may be short-circuited by soldering, etc., respectively.

The patch antenna according to the present invention is not limited to the examples shown in the accompanying drawings and may be variously modified within the scope of the present invention. For example, the recess section and the internal land section within the recess section shown in FIG. 7 may be adopted to the examples shown in FIGS. 1 to 6.

Additionally, for example, although the patch antennas according to the present invention shown in the accompanying drawings each have a configuration in which the resonant frequency can be adjusted by the short-circuiting by means of soldering, the present invention is not limited to this, but adjustment by means of a cutting process may be combined. FIG. 7 is a schematic top view for explaining an example in which an adjustment projection is provided in the patch antenna of the present invention. In FIG. 7, the parts having the same reference numerals as in FIG. 5 are substantially identical with those of the same reference numbers shown in FIG. 5. As shown in FIG. 7, adjustment projections 25a and 25b extending from the radiating element 15 may be provided. When the resonant frequency needs to be adjusted, the adjustment projections 25a and 25b may be cut, or the exterior land sections 21a and 21b may be short-circuited to the radiating element 15 by soldering. That is, when the adjustment projections 25a and 25b are cut to reduce the length thereof, the resonant frequency can be shifted to a higher value. In the example of FIG. 7, four inner land sections are provided. As described above, the patch antenna according to the present invention can have a configuration in which various adjustment means are combined.

What is claimed is:

1. A patch antenna comprising:
a radiating element having a power supply section; and
an adjustment land section for adjusting a resonant frequency of the radiating element, the adjustment land section being short-circuited to the radiating element so as to change an element length of the radiating element as viewed from the power supply section to thereby adjust the resonant frequency of the radiating element.

2. The patch antenna according to claim 1, wherein
the radiating element has an opening section in a center thereof, and
the adjustment land section includes an inner land section disposed within the opening section at a section adjacent to the radiating element.

3. The patch antenna according to claim 2, wherein a plurality of inner land sections are disposed symmetrically with respect to a line connecting the power supply section and a side of the opening section remote from the power supply section or disposed symmetrically with respect to a center point of the opening section.

4. The patch antenna according to claim 2, wherein
the opening section has a substantially square shape,
the inner land section has a substantially triangular shape and is disposed in such a manner that a first apex of the triangular shape is connected near a corner of the opening section and a second apex thereof is away from the corner of the opening section, and
when the resonant frequency needs to be adjusted, a third apex of the triangular shape is short-circuited to the radiating element.

5. The patch antenna according to claim 1, wherein the adjustment land section includes an exterior land section disposed around the radiating element at the section adjacent to a side of the radiating element remote from the power supply section.

6. The patch antenna according to claim 5, wherein the exterior land section has a convex shape, and a projection of the convex shape is disposed facing to the radiating element side.

7. The patch antenna according to claim 1, wherein the radiating element has a plurality of power supply sections, and a plurality of adjustment land sections are provided so as to change the element length as viewed from the power supply sections.

8. The patch antenna according to claim 1, wherein
the radiating element has a recess section at a periphery of the radiating element, and
the adjustment land section has an internal land section disposed within the recess section.

9. The patch antenna according to claim 8, wherein the adjustment land section further includes an exterior land section having a convex shape and disposed adjacent to a periphery of the radiating element, and a projection of the convex shape is disposed facing to the radiating element side.

10. The patch antenna according to claim 1, wherein the adjustment land section and the radiating element are short-circuited by soldering or by a 0Ω resistor.

11. The patch antenna according to claim 1, further comprising an adjustment projection extending from the radiating element, the adjustment projection being cut so as to change the element length as viewed from the power supply section.
